(19) United States
(12) Patent Application Publication
(10) Pub. No.: US 2007/0286382 A1
(43) Pub. Date: Dec. 13, 2007

(54) Telephone exchange apparatus

(75) Inventor: Hitoshi Kato, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/802,990

(22) Filed: May 29, 2007

(30) Foreign Application Priority Data
May 29, 2006 (JP) 2006-148012

(51) Int. Cl. H04M 3/42

(52) U.S. Cl. 379/201.01

(57) ABSTRACT

According to one embodiment, a telephone exchange apparatus which accommodates a plurality of telephone terminals includes a memory to store a management table wherein a terminal identification data (terminal ID) and a connection identification data (connection ID) correspond to an operation data indicating a connected/disconnect status with respect to each of the plurality of telephone terminals, and a controller to connect communication between the plurality of telephone terminals in operation based on the management table, and to update the operation data corresponding to the terminal ID of the relevant telephone terminal within the management table based on a predetermined condition.

### CROSS-REFERENCE TO RELATED APPLICATIONS

This application is based upon and claims the benefit of priority from Japanese Patent Applications No. 2006-148012, filed May 29, 2006, the entire contents of which are incorporated herein by reference.

### BACKGROUND

1. Field

One embodiment of invention relates to a telephone exchange apparatus for connecting communication between telephone terminals through an IP network, such as an IP (Internet Protocol) telephony system.

2. Description of the Related Art

In recent years, a network telephony system (IP telephony system) which interactively transmits/receives images and voices as a packet data in real time through a packet network has become widely used. In this IP telephony system, voice communication can be performed between the IP telephone terminals connected to the packet network, while voice communication can be performed between the IP telephone terminal and the telephone terminal connected to a public network.

In the above IP telephony system, the extension numbers of each of the plurality of IP telephone terminals connected to the packet network are controlled by the telephone exchange apparatus. However, it is strongly desired that the voice communication be established even with an IP telephone terminal which is unregistered with the telephone exchange apparatus and is installed in another place. In such case, when a new IP telephone terminal having an extension number which is registered with the telephone exchange apparatus tries connecting, the telephone exchange apparatus denies the connection. Accordingly, in order to establish the connection of the new IP telephone terminal sharing the same extension number with the currently connected IP telephone, it is necessary to disconnect the currently connected IP telephone terminal in advance and connect the new IP telephone terminal.

Related techniques are disclosed in Jpn. Pat. Appln. KOKAI Publication No. 2004-320629 (Reference 1). In Reference 1, the user authentication number, password and extension number of each of the IP telephone terminals and the IP address of one's own IP telephone terminal are stored on the telephone exchange apparatus. When a user inputs the user authentication number and password using an arbitrary IP telephone terminal, the extension number and IP address of the corresponding user's own IP telephone terminal is retrieved, and personal information is downloaded from user's own IP telephone terminal to the IP telephone terminal to be newly used. Thus, the login process of the new IP telephone terminal is completed.

However, the method of Reference 1 only downloads the personal information established in one's own IP telephone terminal to the IP telephone terminal to be newly used, and does not enable voice communication with the new IP telephone terminal.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic configuration view of an IP telephony system concerned in a first embodiment of the present invention.

FIG. 2 shows an example of a memory content of a connected terminal information database illustrated in FIG. 1.

FIG. 3 shows an example of a memory content of an IP telephone terminal shift password database illustrated in FIG. 1.

FIG. 4 shows an example of a memory content of a shift source terminal information database illustrated in FIG. 1.

FIG. 5 shows an example of a memory content of an IP telephone terminal shiftable/non-shiftable database illustrated in FIG. 1.

FIG. 6 is a sequence diagram illustrating the transmitting/receiving operation of information between a key telephone apparatus and a plurality of IP telephone terminals when switching the IP telephone terminal connected to the key telephone apparatus to a new IP telephone terminal, in the first embodiment.

FIG. 7 is a flowchart illustrating a control process procedure of the key telephone apparatus and the plurality of IP telephone terminals, respectively, in the first embodiment.

FIG. 8 is a sequence diagram illustrating the transmitting/receiving operation of information between the key telephone apparatus and the plurality of IP telephone terminals in a second embodiment of the present invention.

FIG. 9 is a flowchart illustrating a control process procedure of the key telephone apparatus and the plurality of IP telephone terminals, respectively, in the second embodiment.

FIG. 10 is a sequence diagram illustrating the transmitting/receiving operation of information between the key telephone apparatus and the plurality of IP telephone terminals in a third embodiment of the present invention.

FIG. 11 is a sequence diagram illustrating the transmitting/receiving operation of information between the key telephone apparatus and the plurality of IP telephone terminals in a fifth embodiment of the present invention.

### DETAILED DESCRIPTION

Various embodiments according to the invention will be described hereinafter with reference to the accompanying drawings. In general, according to one embodiment of the invention, a telephone exchange apparatus which accommodates a plurality of telephone terminals comprising: a memory to store a management table wherein a terminal identification data (terminal ID) and a connection identification data (connection ID) correspond to an operation data indicating a connected/disconnect status with respect to each of the plurality of telephone terminals; and a controller to connect communication between the plurality of telephone terminals in operation based on the management table, and to update the operation data corresponding to the terminal ID of the relevant telephone terminal within the management table based on a predetermined condition.

### First Embodiment

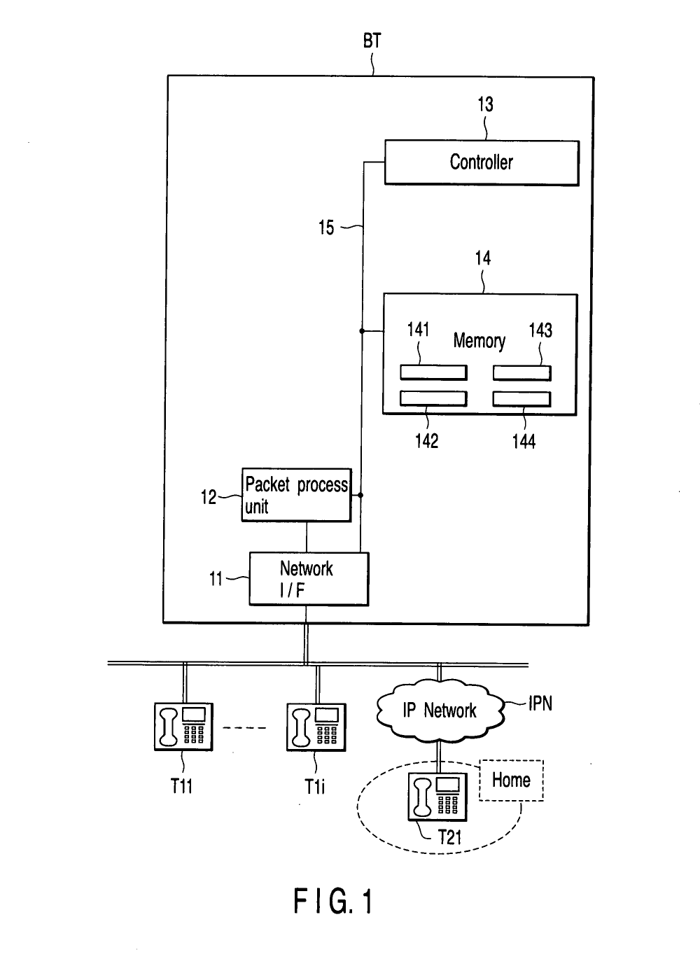

FIG. 1 is a schematic configuration view of an IP telephony system concerned in a first embodiment of the present invention.

This system comprises an IP network IPN for packet communication. The IP network IPN is established in places such as offices and homes. IP telephone terminals T11 to T1i (it is a whole number) are connected in offices, and an IP telephone terminal T21 is connected at home. In the present embodiment, a user moves from office to home and uses the IP telephone terminal T21 at home (destination) using the same extension number (connection ID) as the IP telephone terminal T11 (source) which is in operation at the office. Further, the IP telephone terminals T11 to T1i and T21 comprise a communication process function and a media information process function of, for example, images.

In addition, these IP telephone terminals T11 to T1i and T21 are connected to a key telephone apparatus BT, which functions as a telephone exchange apparatus, through the IP network IPN. Further, the key telephone apparatus BT is considered as being established in the office.

The key telephone apparatus BT comprises a network interface (I/F) unit 11, a packet process unit 12, a controller 13 and a memory 14. These network interface unit 11, packet process unit 12, controller 13 and memory 14 are connected to each other through a data highway 15.

The IP network IPN is connected to the network interface unit 11. The network interface unit 11 performs an interface process between the connected IP network IPN. Further, the network interface unit 11 gives and receives various control information related to the above interface process between the controller 13 through the data highway 15.

The packet process unit 12 processes control packets and voice packets received from the IP network IPN.

The controller 13 comprises, for example, CPU, ROM and RAM, and controls each unit of the key telephone apparatus BT by a software process.

The memory 14 stores routing information and so forth required for connection control of the controller 13. Further, the memory 14 stores a connected terminal information database (referred to as connection DB hereinafter) 141, an IP telephone terminal shift password database (referred to as password DB hereinafter) 142, a shift source terminal information database (referred to as source DB) 143 and an IP telephone terminal the shiftable/non-shiftable database (referred to as shiftable/non-shiftable DB hereinafter) 144.

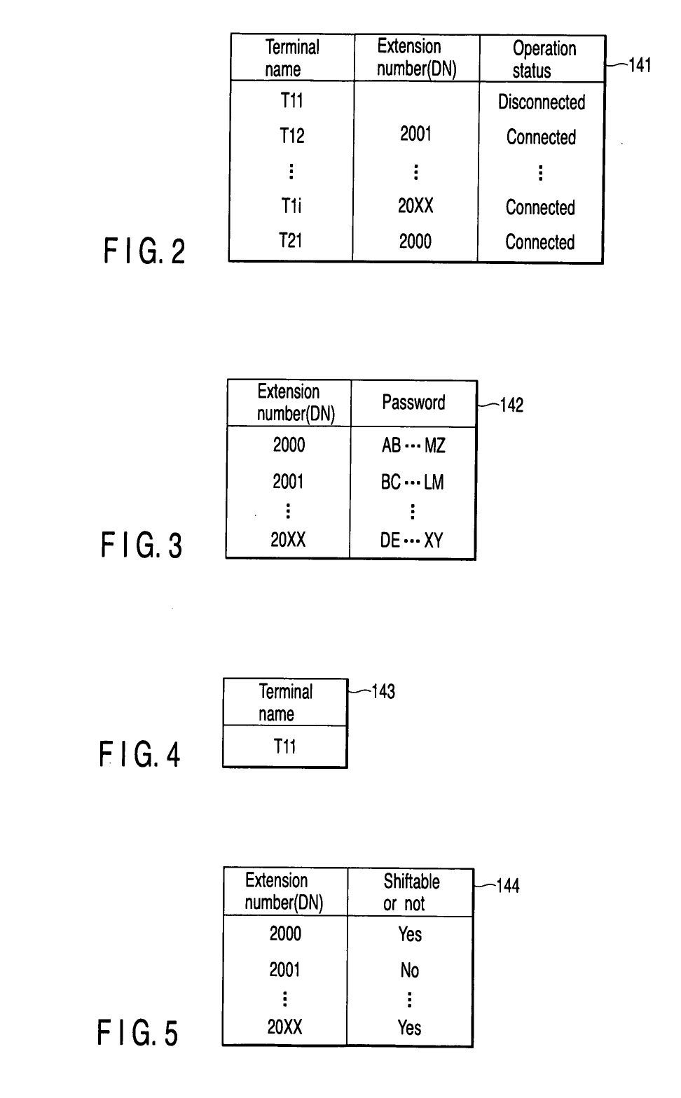

The connection DB 141 stores each information of the IP telephone terminals connected to the key telephone apparatus BT. As shown in FIG. 2, the connection DB 141 stores identification data (terminal name) of the terminals allocated respectively to the IP telephone terminals T11 to T1i and T21 in advance, connection identification data (extension number: DN) used at each terminal, and each operation status of said terminals which corresponds to the corresponding identification data and the connection identification data.

As shown in FIG. 3, the password DB 142 stores each registered password for each extension number. The password is used to connect the IP telephone terminals to the key telephone apparatus BT.

The source DB 143 stores information indicating the source IP telephone terminal with respect to the extension number which is being shifted. For example, as shown in FIG. 4, the terminal name of the IP telephone terminal T11 is stored.

As shown in FIG. 5, the shiftable/non-shiftable DB 144 stores information indicating whether or not to permit connection shift between the terminals using identical extension numbers in correspondence with each extension number.

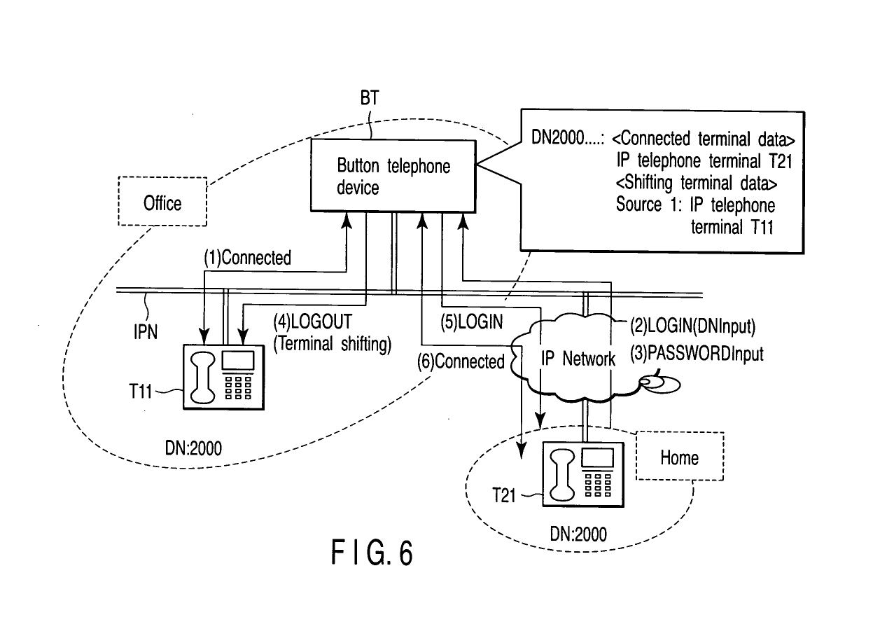

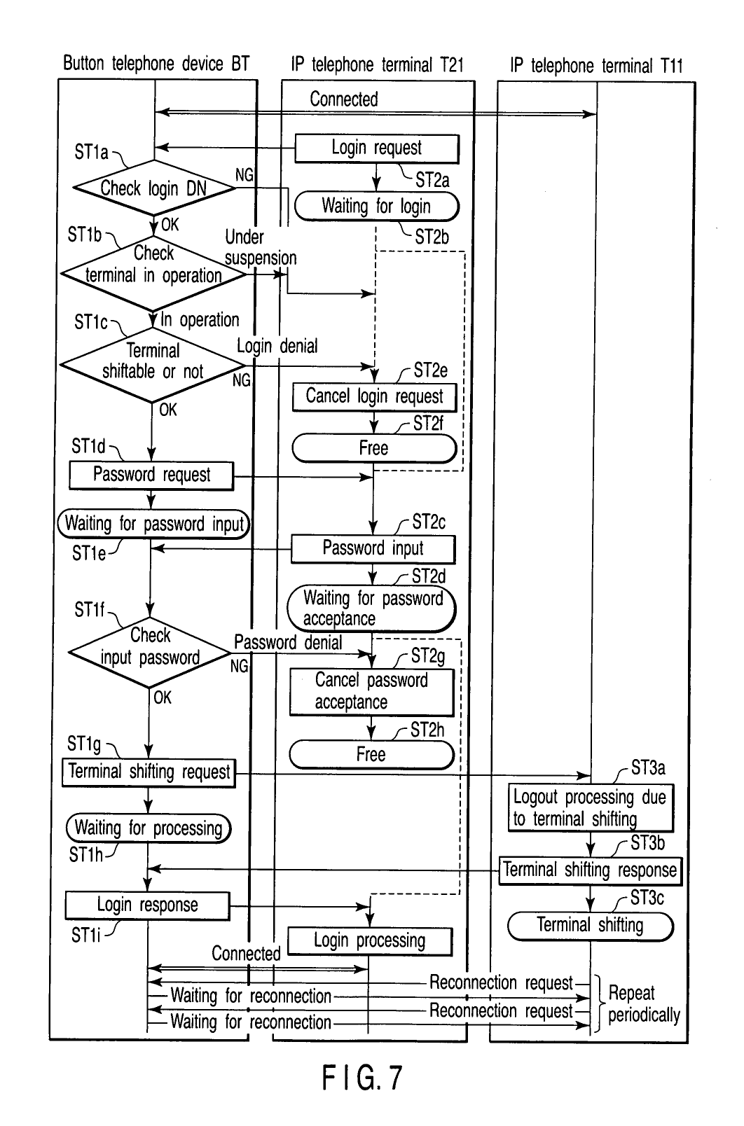

The operation of the key telephone apparatus BT in the above configuration will be explained. FIG. 6 is a sequence diagram showing the transmitting/receiving operation of information between the key telephone apparatus BT and the IP telephone terminals T11 and T21 when shifting the connection with the key telephone apparatus BT from the IP telephone terminal T11 to the IP telephone terminal T21. FIG. 7 is a flowchart showing the control process procedure of the key telephone apparatus BT and the IP telephone terminals T11 and T12.

Suppose that the IP telephone terminal T11 is currently connected to the key telephone apparatus BT using the extension number “DN2000”, and the user performs a login operation by the IP telephone terminal T21 assigning the extension number “DN2000” to request connection to the key telephone apparatus BT.

By this operation, the IP telephone terminal T21 transmits the login request to the key telephone apparatus BT (block ST2a). With this, the IP telephone terminal T21 becomes a login waiting state (block ST2b). The above login request includes identification data “T21” of the IP telephone terminal T21 and the extension number “DN2000”.

Having received the above login request, by reference to the connection DB 141, the controller 13 of the key telephone apparatus BT determines whether or not the extension number “DN2000” included in the login request is currently connected (block ST1a). In the case where the extension number “DN2000” is determined as connected, the controller 13 determines whether or not the IP telephone terminal T11 corresponding to the extension number “DN2000” is in operation (block ST1b). When the IP telephone terminal T11 is determined as currently in operation, the controller 13 refers to the shiftable/non-shiftable DB 144 and determines whether or not connection shift between the terminals is permitted with regard to the extension number “DN2000” (Block ST1c).

Here, in the case where the connection shift between the terminals is permitted with regard to the extension number “DN2000”, the controller 13 of the key telephone apparatus BT requests the IP telephone terminal T21 to input the password (block ST1d), and becomes a password input waiting state(block ST1e). When the IP telephone terminal T21 receives this password input request, it displays a message on the indicator encouraging password input.

When the user inputs the password corresponding to the extension number “DN2000” at the IP telephone terminal T21, the IP telephone terminal T21 transmits the input password to the key telephone apparatus BT (block ST2c) and becomes a password acceptance waiting state(block ST2d).

The controller 13 of the key telephone apparatus BT cross-checks the above password sent from the IP telephone terminal T21 and the password registered in the extension number “DN2000” within the password DB 142 (block ST1f). In the case where the above password is determined as correct (OK), the controller 13 transmits a terminal shift request to the IP telephone terminal T11 to request the shift of the terminal (block ST1g) and becomes a response waiting status from the IP telephone terminal T11 (block ST1h).

The IP telephone terminal T11 which receives the terminal shift request transmits a terminal shift response to the key telephone apparatus BT (block ST3b) after performing a logout process for the terminal shift (block ST3a) and becomes a “terminal shifting” status (block ST3c).

The key telephone apparatus BT which receives a response of terminal shift from the IP telephone terminal T11, transmits a login response indicating login acceptance to the IP telephone terminal T21 (block ST1i). By carrying out the login process upon receiving to the above login response, the IP telephone terminal T21 becomes connected to the key telephone apparatus BT.

The controller 13 of the key telephone apparatus BT stores on the connection DB 141 the extension number “DN2000” and the operation status “connected” to correspond to the identification data of the IP telephone terminal T21. In addition, the controller 13 updates the operation data corresponding to the identification data indicating the IP telephone terminal T11 within the connection DB 141 from “connected” to “disconnected”. Further, the controller 13 stores on the source DB 143 that the source with respect to the extension number “DN2000” is the “IP telephone terminal T11”.

The IP telephone terminal T11 in connection shift periodically and repeatedly transmits a reconnection request to the key telephone apparatus BT. The key telephone apparatus BT which receives the reconnection request from the IP telephone terminal T11 retrieves from the connection DB 141 the connection status of the extension number “DN2000”. Having confirmed that the IP telephone terminal T21 is currently connected, the key telephone apparatus BT responds to the IP telephone terminal T11 to wait for reconnection.

Further, in cases where the extension number to which a login is requested in the above block ST1a does not exist within the connection DB 141, where the IP telephone terminal which corresponds to the extension number is under suspension in the above block ST1b, or where there is a “shift denial” in the above block ST1c, the key telephone apparatus BT refuses the login for the IP telephone terminal T21. Then the IP telephone terminal T21 cancels the login request (block ST2e) and becomes free (block ST2f).

Additionally, in the case where the input password is incorrect (NG) in the above block ST1f, the key telephone apparatus BT transmits a message of password denial to the IP telephone terminal T21. Then the IP telephone terminal T21 cancels the password acceptance (block STg) and becomes free (block ST2h).

As mentioned above, in the first embodiment, when the controller 13 of the key telephone apparatus BT receives a login request including the identical extension number “DN2000” from the IP telephone terminal T21 established in a destination household, the controller 13 determines whether or not the IP telephone terminal corresponding to this extension number “DN2000” exists in the connection DB 141. In the case where the IP telephone terminal T11 corresponding to the extension number “DN2000” exists in the connection DB 141, the controller 13 updates the operation status corresponding to the identification data indicating the IP telephone terminal T11 within the connection DB 141 from “connected” to “disconnected”. In addition, the controller 13 stores within the connection DB141 the identification data of the IP telephone terminal T21, the extension number “DN2000” and the operation data indicating “connected” so as to correspond to each other. Further, the controller 13 stores information indicating the IP telephone terminal T11, from which the extension number is shifted, in the source DB 143.

Thus, according to the first embodiment, the IP telephone terminal T21 at the shifted destination can establish phone calls by using the extension number “DN2000” by a simple login operation and password input, and without having to disconnect the IP telephone terminal T11 in operation at the office, from which the connection is shifted, in advance.

### Second Embodiment

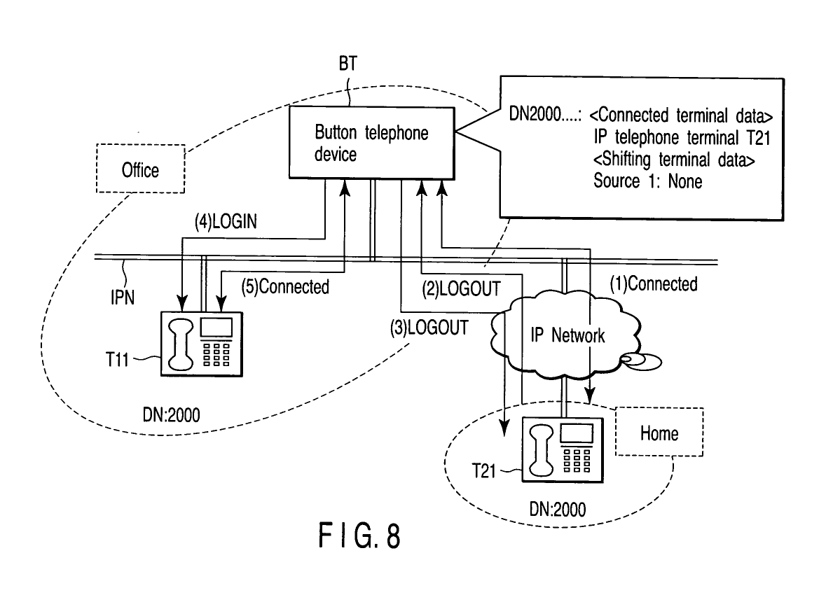

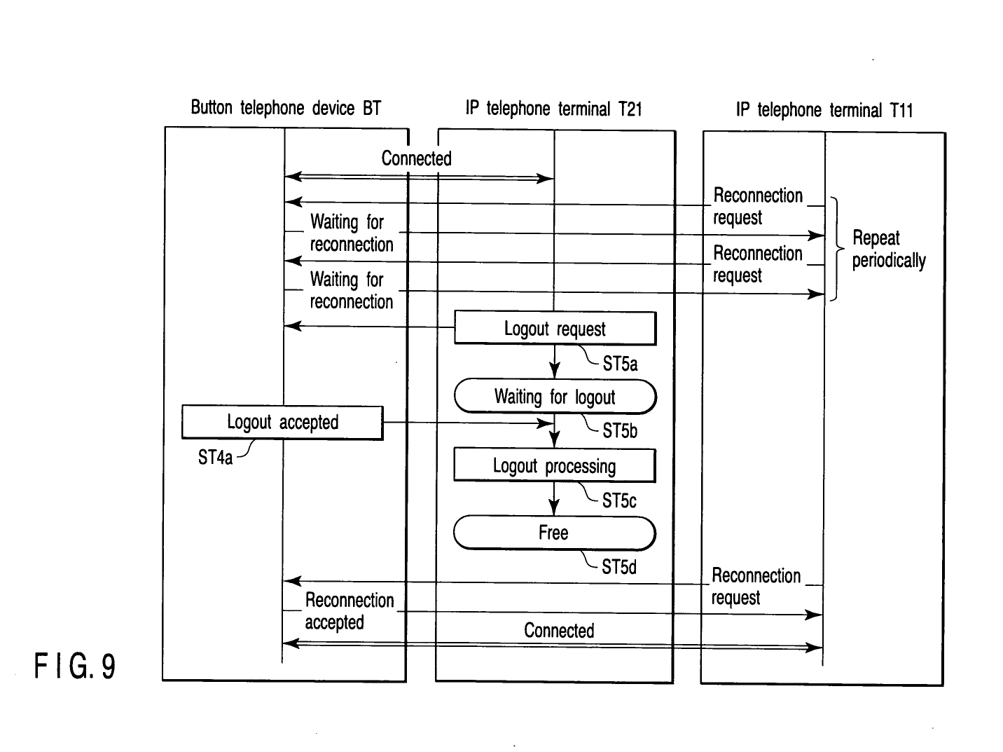

As a second embodiment of the present invention, FIG. 8 shows a sequence diagram illustrating the transmission/reception operation of information between the key telephone apparatus BT and the IP telephone terminals T11 and T21 when the IP telephone terminal T21 disconnects its connection with the key telephone apparatus BT, and the IP telephone terminal T11 reestablishes its connection with the key telephone apparatus BT. FIG. 9 is a flowchart illustrating the control process procedures of the key telephone apparatus BT and the IP telephone terminals T11 and T21.

Suppose that the IP telephone terminal T21 is currently connected to the key telephone apparatus BT, and the user carries out operation to request disconnection from the key telephone apparatus BT, i.e., a logout operation, at the IP telephone terminal T21.

In such case, the IP telephone terminal T21 transmits a logout request to the key telephone apparatus BT (block ST5a). With this, the IP telephone terminal T21 becomes a logout waiting state (block ST5b).

The key telephone apparatus BT receiving the logout request accepts the logout request (block ST4a). The key telephone apparatus BT updates the operation status of the IP telephone terminal T21 within the connection DB 141 to “disconnected” and transmits a message indicating that the logout has been accepted to the IP telephone terminal T21. Having received such message, the IP telephone terminal T21 performs a logout process (block ST5c) and becomes a vacant status (block ST5d).

The IP telephone terminal T11 in connection shift periodically and repeatedly transmits a reconnection request to the key telephone apparatus BT.

The key telephone apparatus BT receiving the reconnection request from the IP telephone terminal T11 refers to the connection DB 141 and confirms that the connection status of the IP telephone terminal T21 is “disconnected”. Further, the key telephone apparatus BT refers to the source DB 143 and confirms that the source is the IP telephone terminal T11. With that, the key telephone apparatus BT transmits a message indicating that the IP telephone terminal T11 is accepted as the reconnection destination, and updates the operation status of the IP telephone terminal T11 within the connection DB 141 as “connected” and the source DB 143 as “none”.

Having received the message of reconnection acceptance, the IP telephone terminal T11 becomes connected to the key telephone apparatus BT.

As mentioned above, according to the second embodiment, phone calls can be established at the IP telephone terminal T11, which is the source terminal, by carrying out a simple operation procedure, such as sending out a logout request to the key telephone apparatus BT by the IP telephone terminal T21, which is the destination terminal.

### Third Embodiment

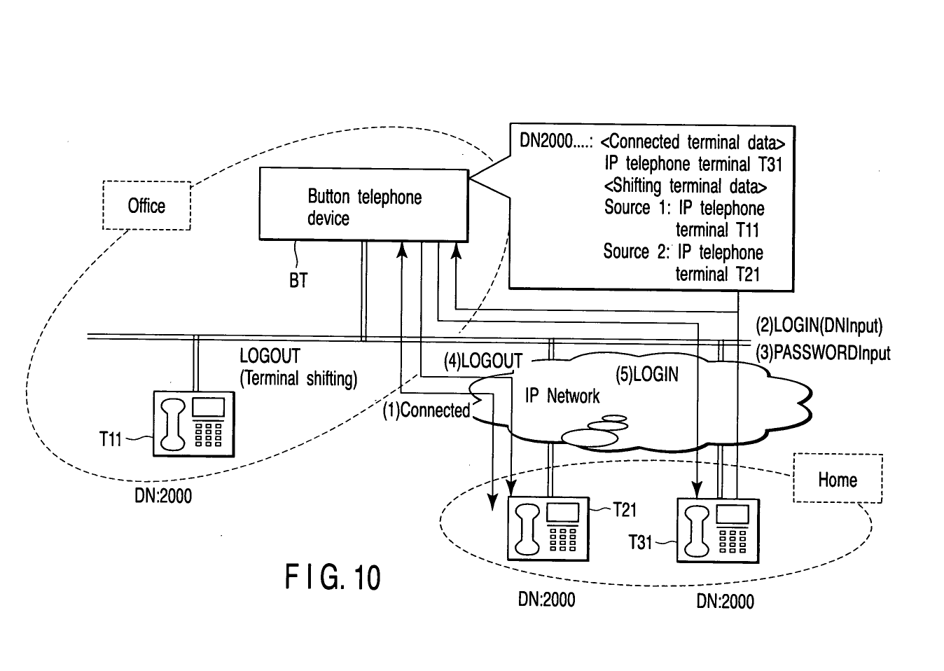

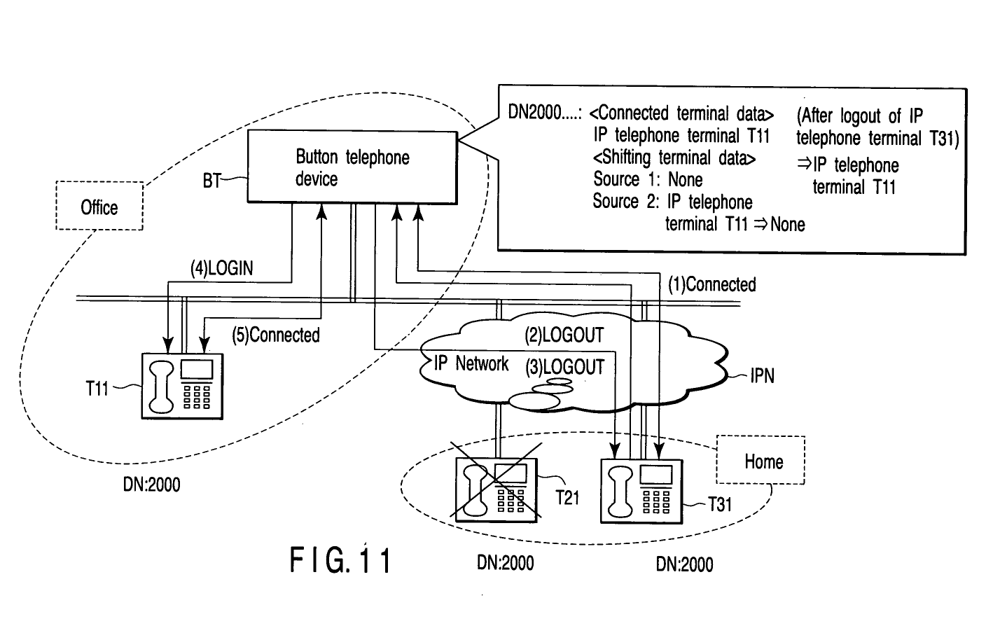

As a third embodiment of the present invention, FIG. 10 illustrates a sequence diagram showing the transmission/reception operation of information between the key telephone apparatus BT and the IP telephone terminals T11, T21 and T31 in the case where a new IP telephone terminal T31 attempts to establish connection with the key telephone terminal by the identical extension number “DN2000” when the IP telephone terminal T21 is connected.

Suppose that the IP telephone terminal T21 is currently connected to the key telephone apparatus BT, and a user carries out a login operation to the key telephone apparatus BT by the IP telephone terminal T31 using the extension number “DN2000”.

In such operation, the IP telephone terminal T31 transmits a login request to the key telephone apparatus BT. With this, the IP telephone terminal T31 becomes a login waiting state. The above login request includes identification data of the IP telephone terminal T31 and the extension number “DN2000”.

Having received the above login request, the key telephone apparatus BT determines whether or not the extension number “DN2000” included in the login request exists within the connection DB 141. In the case where the extension number “DN2000” exists within the connection DB 141, the key telephone apparatus BT determines whether or not the IP telephone terminal T21 corresponding to the extension number “DN2000” is in operation. In the case where the IP telephone terminal T21 is in operation, with reference to the shiftable/non-shiftable DB 144, the key telephone apparatus BT determines whether or not the extension number “DN2000” is shiftable between terminals.

In the case where it is determined that the extension number “DN2000” is shiftable, the key telephone apparatus BT requests the IP telephone terminal T31 to input the password, and becomes a password input waiting state. Having received the password input request, the IP telephone terminal T31 displays the message for password input on the indicator.

Suppose that the user inputs the password in the IP telephone terminal T31 in this state, the IP telephone terminal T31 transmits the password to the key telephone apparatus BT and becomes a password acceptance waiting state.

The key telephone apparatus BT cross-checks the password corresponding to the extension number “DN2000” within the password DB142 and the password transmitted from the IP telephone terminal T31. Here, in the case where the input password is correct, the key telephone apparatus BT transmits a terminal shift request to the IP telephone terminal T21 and becomes a response waiting state.

Having received the terminal shift request, the IP telephone terminal T21 implements a logout process for terminal shift, transmits a terminal shift response to the key telephone apparatus BT, and becomes a “terminal shifting” state.

Having received the terminal shift response from the IP telephone terminal T21, the key telephone apparatus BT transmits a login response to the IP telephone terminal T31 and establishes a connected state with the IP telephone terminal T31.

The key telephone apparatus BT stores on the connection DB 141 the extension number “DN2000” and operation status “connected” corresponding to the identification data of the IP telephone terminal T31. In addition, the key telephone apparatus BT updates the operation status of the IP telephone terminal T21 within the connection DB 141 to “disconnected”. Further, the key telephone apparatus BT stores on the source DB 143 that the source terminals of the extension number “DN2000” are “IP telephone terminal T11” and “IP telephone terminal T21”.

The IP telephone terminals T11 and T21 in connection shift periodically transmit a reconnection request to the key telephone apparatus BT. Having received the reconnection request from the IP telephone terminals T11 and T21, the key telephone apparatus BT retrieves the connection status of the extension number “DN2000” from the connection DB 141 and confirms that the IP telephone terminal T31 remains connected. The key telephone apparatus BT then makes a reconnection waiting response to the IP telephone terminals T11 and T21.

As mentioned above, according to the third embodiment, even when the user frequently shifts from the IP telephone terminal T21 to the IP telephone terminal T31, phone calls may be established by the IP telephone terminal T31, which is the destination terminal, using the extension number “DN2000”. This can be done without having to cancel the operation status of the IP telephone terminal T21 in advance, but by a simple operation procedure such as, a login operation and password input from the IP telephone terminal T31.

### Fourth Embodiment

A fourth embodiment of the present invention is adapted in the case where the IP telephone terminal T31 in connection shift disconnects its connection with the key telephone apparatus BT in the above mentioned third embodiment. The fourth embodiment will be explained in reference to FIG. 8.

Here, the key telephone apparatus BT retrieves a reestablished terminal from the previous source terminal of the source DB 143, and confirms that the reestablished terminal is the IP telephone terminal T21. The key telephone apparatus BT transmits a message indicating reconnection acceptance to the IP telephone terminal T21 and updates the operation status of the IP telephone terminal T21 within the connection DB 141 to “connected”.

Having received the reconnection acceptance, the IP telephone terminal T21 is now connected to the key telephone apparatus BT.

### Fifth Embodiment

As a fifth embodiment of the present invention, FIG. 11 illustrates a sequence diagram showing the transmission/reception operation of information between the key telephone apparatus BT and the IP telephone terminals T11, T21 and T31 in the case where the IP telephone terminal T31 in connection shift disconnects its connection with the key telephone apparatus BT, and the IP telephone terminal T21 cannot be reestablished.

Suppose that the IP telephone terminal T31 is currently connected to the key telephone apparatus BT, and a user carries out a logout operation for the key telephone apparatus BT by the IP telephone terminal T31.

In such operation, the IP telephone terminal T31 transmits a logout request to the key telephone apparatus BT and becomes a logout waiting state.

Having received the logout request, the key telephone apparatus BT accepts the logout request, updates the operation status of the IP telephone terminal T31 within the connection DB 141 to “disconnected” and transmits the message of logout acceptance to the IP telephone terminal T31.

Having received the logout acceptance, the IP telephone terminal T31 carries out a logout process and becomes free.

The IP telephone terminal T11 in connection shift periodically and repeatedly transmits a reconnection request to the key telephone apparatus BT. Meanwhile, the IP telephone terminal T21 in connection shift is considered not to transmit the reconnection request to the key telephone apparatus BT.

Having received the reconnection request from the IP telephone terminal T11, the key telephone apparatus BT refers to the connection DB 141 to confirm that the operation status of the IP telephone terminal T31 is “disconnected”. In addition, the key telephone apparatus BT refers to the source DB 143 to confirm that the reestablished terminal is the IP telephone terminal T11. The key telephone apparatus BT transmits a message of reconnection acceptance to the IP telephone terminal T11, updates the operation status of the IP telephone terminal T11 within the connection DB 141 to “connected”, and updates the source DB 143 to “none”.

Having received the message of reconnection acceptance, the IP telephone terminal T11 is now connected to the key telephone apparatus BT.

In addition, in the case where there is no “reconnection request” from the source terminals of IP telephone terminals T11 and T21, the key telephone apparatus BT clears the source DB 143 entirely and cancels the connection shift state.

As mentioned above, according to the fifth embodiment, in the case where the IP telephone terminal T31, which is the destination terminal, performs a logout operation, and the IP telephone terminal T21, which is the previous source terminal, cannot be reestablished, the key telephone apparatus BT uses data stored in the source DB143 indicating the “IP telephone terminal T11”. As such, the key telephone apparatus BT is able to reestablish the other source terminal, i.e. the IP telephone terminal T11, promptly without waiting for the maintenance personnel to restore the IP telephone terminal T21.

### Other Embodiments

The present invention is not restricted to each of the above embodiments. For example, each of the above embodiments explain the example of updating the connection DB and the source DB under the condition that the login and logout operations are performed by the IP telephone terminal at the destination terminal. However, this is not restricted. Therefore, for instance, it is also possible to update the connection DB and the source DB by carrying out the login operation at the IP telephone terminal, which is the source terminal. It is also fine to update the connection DB and the source DB using other conditions.

In addition, each of the above embodiments can be adapted for personal computers equipped with an IP telephone application or electronic devices handling voice signals. Other various modifications can be made within the scope of the present invention, on such as the type (it does not have to be exclusive to a key telephone apparatus, and can be a PBX) and functional configuration of telephone exchange apparatus, the type of IP telephone terminal, memory content of various databases, connection alteration control sequence of an IP telephone terminal and so forth.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone exchange apparatus which accommodates a plurality of telephone terminals comprising:
a memory to store a management table wherein a terminal identification data (terminal ID) and a connection identification data (connection ID) correspond to an operation data indicating a connected/disconnect status with respect to each of the plurality of telephone terminals; and
a controller to connect communication between the plurality of telephone terminals in operation based on the management table, and to update the operation data corresponding to the terminal ID of the relevant telephone terminal within the management table based on a predetermined condition.

2. The telephone exchange apparatus according to claim 1, wherein, under the condition that a first telephone terminal which is one of the plurality of telephone terminals is in operation in the management table, and a connection request including the same connection ID as the first telephone terminal is received from a second telephone terminal which is different from the first telephone terminal, the controller updates the operation data corresponding to the terminal ID of the first telephone terminal within the management table from “connected” to “disconnected” based on the connection ID, and stores the operation data indicating “connected” for the terminal ID and the connection ID of the second telephone terminal on the management table.

3. The telephone exchange apparatus according to claim 2, wherein, under the condition of receiving a request for disconnection from the second telephone terminal in operation within the management table, the controller updates the operation data corresponding to the terminal ID of the second telephone terminal within the management table from “connected” to “disconnected” and updates the operation data corresponding to the terminal ID and the connection ID of the first telephone terminal from “disconnected” to “connected”.

4. The telephone exchange apparatus according to claim 2, wherein, under the condition of receiving a connection request including the same connection ID as the second telephone terminal in operation within the management table from a third telephone terminal which is different from the first and second telephone terminals, the controller updates the operation data corresponding to the terminal ID of the second telephone terminal within the management table from “connected” to “disconnected” based on the connection ID, and stores the operation data indicating “connected” for the terminal ID and the connection ID of the third telephone terminal on the management table.

5. The telephone exchange apparatus according to claim 4, wherein, under the condition of receiving a disconnection request from the third telephone terminal in operation within the management table, the controller updates the operation data corresponding to the terminal ID of the third telephone terminal within the management table from “connected” to “disconnected”, and updates the operation data corresponding to the terminal ID and connection ID of the second telephone terminal from “disconnected” to “connected”.

6. The telephone exchange apparatus according to claim 4, wherein, under the condition of receiving a disconnection request from the third telephone terminal in operation within the management table and, further, being unable to reestablish the second telephone terminal, the controller updates the operation data corresponding to the terminal ID of the third telephone terminal within the management table from “connected” to “disconnected” and updates the operation data corresponding to the terminal ID and the connection ID of the first telephone terminal from “disconnected” to “connected”.

7. The telephone exchange apparatus according to claim 4, wherein,
in the case where the management table comprises a first table and a second table, the first table which has the terminal ID and the connection ID of each of the plurality of telephone terminals correspond to the operation data indicating a connected/disconnected status thereof, and the second table which stores the terminal IDs of each of the first and second telephone terminals, and
the controller updates the operation data corresponding to the terminal ID of the third telephone terminal within the first table from “connected” to “disconnected” and eliminates the terminal IDs of each of the first and second telephone terminals within the second table, under the condition of receiving a disconnection request from the third telephone terminal in operation within the first table and being unable to reestablish the first and the second telephone terminals.
